(19) United States
(12) Patent Application Publication
(10) Pub. No.: US 2025/0327667 A1
(43) Pub. Date: Oct. 23, 2025

(54) MOBILE OBJECT POSITIONING DEVICE

(71) Applicant: Mitsubishi Electric Corporation, Tokyo (JP)

(72) Inventors: Hiroaki KITANO, Tokyo (JP); Shota KAMEOKA, Tokyo (JP); Norizumi MOTOOKA, Tokyo (JP); Masaya SAKAI, Tokyo (JP); Takeya SHIMA, Tokyo (JP)

(73) Assignee: Mitsubishi Electric Corporation, Tokyo (JP)

(21) Appl. No.: 18/861,897

(22) PCT Filed: May 10, 2022
(86) PCT No.: PCT/JP2022/019805

§ 371 Date: Oct. 31, 2024

(51) Int. Cl. G01C 21/16

(52) U.S. Cl. CPC G01C 21/165

(57) ABSTRACT

The present disclosure has an object of providing a mobile object positioning device positioning a mobile object using a sensor with high accuracy. The mobile object positioning device according to the present disclosure includes: a sensor information obtainment unit obtaining a sensor value on a mobile object, the sensor value being detected by a sensor; a sideslip angle estimation unit estimating a sideslip angle of the mobile object using the sensor value; and an inertial positioning unit performing inertial positioning of the mobile object using the sensor value and the sideslip angle, wherein the sideslip angle estimation unit estimates the sideslip angle based on the sensor value and a mixture model obtained by weighting a plurality of motion models on the mobile object based on state quantities of the mobile object and integrating the plurality of motion models.

### TECHNICAL FIELD

The present disclosure relates to positioning of a mobile object.

### BACKGROUND ART

Automated driving of a mobile object requires controlling the mobile object so that the mobile object detects a region in which the mobile object should travel, generates a traveling route that is a route through which the mobile object should travel, and travels through the generated traveling route.

What have conventionally been conceived are systems each detecting a road using satellite positioning results from a global navigation satellite system (GNSS) and map data surveyed with high accuracy. Particularly, recent years have seen practical use of systems each positioning a location of a vehicle with high accuracy, which are typified by quasi-zenith satellites and network real-time kinematic positioning (RTK).

Patent Document 1 describes a self-position estimation apparatus including: an obtainment unit that obtains a speed of a subject vehicle which has been detected by a speed sensor, an angular velocity of the subject vehicle which has been detected by an angular velocity sensor, and a position and an attitude angle of the subject vehicle which have been detected by a positioning device; a second self-position estimation unit that estimates a second position that is a position of the subject vehicle, based on a predetermined vehicle body sideslip angle, and the speed and the angular velocity of the subject vehicle which have been obtained by the obtainment unit; an attitude angle correction amount calculating unit that calculates an attitude angle correction value, based on a deviation between the second position estimated by the second self-position estimation unit and the position of the subject vehicle which has been obtained by the obtainment unit, when the obtainment unit obtains the position of the subject vehicle; and a first self-position estimation unit that estimates a first position that is a position of the subject vehicle, based on the speed of the subject vehicle which has been obtained by the obtainment unit, the angular velocity of the subject vehicle, the position and the attitude angle of the subject vehicle which have been previously obtained by the obtainment unit, the attitude angle correction value calculated by the attitude angle correction amount calculating unit, and the vehicle body sideslip angle when the obtainment unit does not obtain the position of the subject vehicle.

### PRIOR ART DOCUMENT

### Patent Document

Patent Document 1: Japanese Patent Application Laid-Open No. 2020-112490

### SUMMARY

### Problem to be Solved by the Invention

In the configuration of Patent Document 1, the position and the attitude angle of a mobile object are estimated in consideration of the sideslip angle of the mobile object. This sideslip angle is estimated by referencing a predefined table based on a steering angle and a vehicle speed, or on the assumption that the mobile object is steady-state cornering with the steering angle being not changed. Thus, the accuracy of estimating the attitude angle may decrease in a circumstance where the steering angle is momentarily changed.

The technology of the present disclosure has been conceived to solve the problem, and has an object of providing a mobile object positioning device that positions a mobile object using a sensor with high accuracy.

### Means to Solve the Problem

One of mobile object positioning devices of the present disclosure includes: a sensor information obtainment unit to obtain a sensor value on a mobile object, the sensor value being detected by a sensor; a sideslip angle estimation unit to estimate a sideslip angle of the mobile object using the sensor value; and an inertial positioning unit to perform inertial positioning of the mobile object using the sensor value and the sideslip angle, wherein the sideslip angle estimation unit estimates the sideslip angle based on a mixture model and the sensor value, the mixture model being obtained by weighting a plurality of motion models on the mobile object based on state quantities of the mobile object and integrating the plurality of motion models.

### Effects of the Invention

Since the mobile object positioning device according to the present disclosure estimates, with high accuracy, the side slip angle using the mixture model obtained by integrating a plurality of motion models, the mobile object positioning device can position a mobile object with high accuracy. The object, features, aspects, and advantages of the present disclosure will become more apparent from the following detailed description and the accompanying drawings.

### BRIEF DESCRIPTION OF DRAWINGS

FIG. 1 illustrates an overall structure of a vehicle on which a mobile object positioning device according to Embodiment 1 is mounted.

FIG. 2 is a block diagram illustrating a configuration of the mobile object positioning device according to Embodiment 1.

FIG. 3 is a flowchart illustrating processes to be performed by the mobile object positioning device according to Embodiment 1,

FIG. 4 is a schematic diagram illustrating a first motion model.

FIG. 5 is a schematic diagram illustrating a second motion model.

FIG. 6 illustrates a weighting function.

FIG. 7 is a comparison chart for the first motion model, the second motion model, and a mixture model.

FIG. 8 is a block diagram illustrating a configuration of a mobile object positioning device according to a modification of Embodiment 1.

FIG. 9 is a block diagram illustrating a configuration of a mobile object positioning device according to a modification of Embodiment 1.

FIG. 10 is a block diagram illustrating a configuration of a mobile object positioning device according to a modification of Embodiment 1.

FIG. 11 illustrates a hardware configuration of the mobile object positioning device.

FIG. 12 illustrates a hardware configuration of the mobile object positioning device.

### DESCRIPTION OF EMBODIMENTS

### A. Embodiment 1

### A-1. Structure

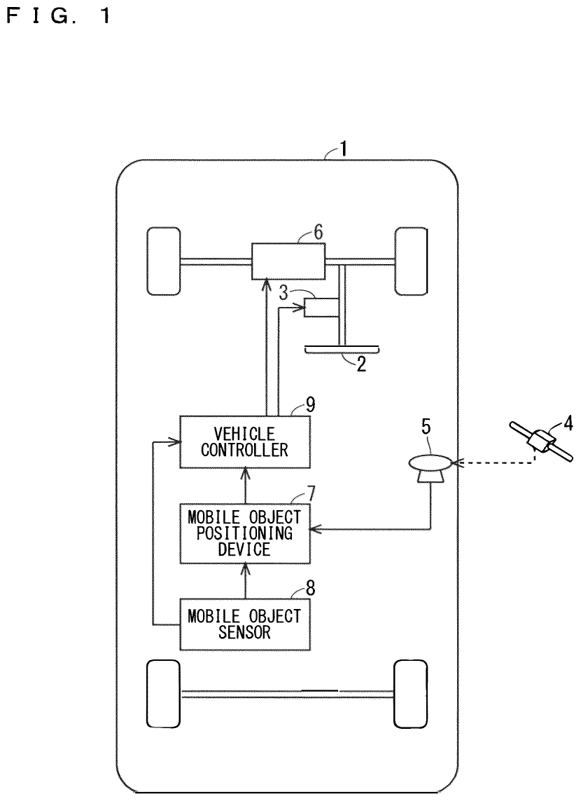

FIG. 1 illustrates an overall structure of a vehicle 1 on which a mobile object positioning device 7 according to Embodiment 1 is mounted. The vehicle 1 is an example mobile object, As illustrated in FIG. 1, the vehicle 1 includes a steering wheel 2, a steering actuator 3, an antenna 5, a drive 6, the mobile object positioning device 7, a mobile object sensor 8, and a vehicle controller 9. The vehicle 1 further includes a brake for braking the vehicle 1, which is not illustrated in FIG. 1.

The steering actuator 3 is attached to the steering wheel 2 that operates two tires of front wheels. The steering actuator 3 includes, for example, an electric power steering (EPS) motor and an electronic control unit (ECU). The steering actuator 3 operates in accordance with a steering command from the vehicle controller 9, so that the rotations of the steering wheel 2 and the front wheels can be controlled. The steering actuator 3 controls steering in accordance with a steering command value received from the vehicle controller 9 so that the vehicle 1 travels along a road.

The drive 6 is provided on a front axle of the vehicle 1, and drives the vehicle 1. The drive 6 includes, for example, a drive motor, an ECU, and the brake. The drive 6 operates in accordance with a command value of a speed or an acceleration which has been received from the vehicle controller 9, so that the vehicle 1 can be braked and driven. The drive 6 controls braking and driving of the vehicle 1 in accordance with the command value of the speed or the acceleration which has been received from the vehicle controller 9 so that the speed of the vehicle 1 adapts to a traffic situation.

The antenna 5 receives a satellite signal from a satellite 4, and transmits the received satellite signal to the mobile object positioning device 7. The satellite 4 includes, for example, a plurality of Global Positioning System (GPS) satellites. The satellite 4 is not limited to the GPS satellites. Another positioning satellite such as the Global Navigation Satellite System (GLONASS) can be used as the satellite 4.

The mobile object sensor & detects a state quantity of the vehicle 1 such as a steering angle or a vehicle speed, and transmits the detected state quantity to the mobile object positioning device 7.

The mobile object positioning device 7 measures a position of the vehicle 1, based on the satellite signal received from the antenna 5 and the state quantity of the vehicle 1 which has been detected by the mobile object sensor 8, and transmits the measured position of the vehicle 1 to the vehicle controller 9.

The vehicle controller 9 outputs command values to the steering actuator 3 and the drive 6, based on the position of the vehicle 1 which has been measured by the mobile object positioning device 7, the state quantity of the vehicle 1 which has been detected by the mobile object sensor 8, and a recognition result of, for example, a camera or a millimeter wave radar that is not illustrated.

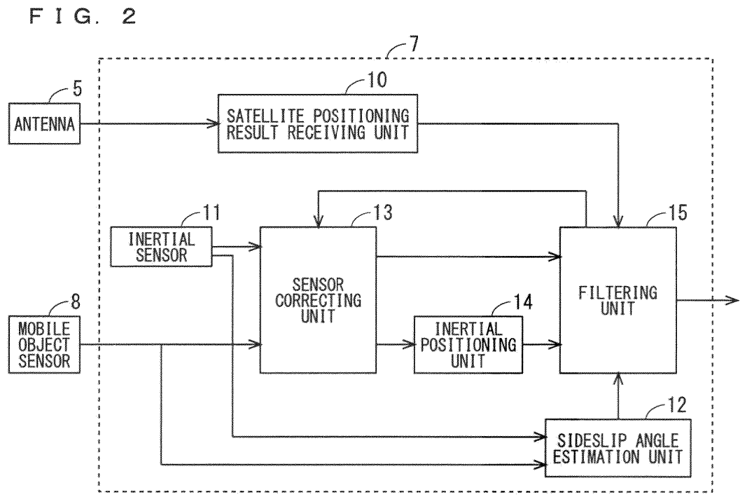

Next, a configuration of the mobile object positioning device 7 according to Embodiment 1 will be described with reference to FIG. 2. FIG. 2 is a block diagram illustrating the configuration of the mobile object positioning device 7 according to Embodiment 1.

As illustrated in FIG. 2, the mobile object positioning device 7 includes a satellite positioning result receiving unit 10, an inertial sensor 11, a sideslip angle estimation unit 12, a sensor correcting unit 13, an inertial positioning unit 14, and a filtering unit 15. Besides, the mobile object positioning device 7 includes a sensor information obtainment unit that is not illustrated in FIG. 2. Furthermore, the antenna 5 and the mobile object sensor 8 are connected to the mobile object positioning device 7.

The satellite positioning result receiving unit 10 converts the satellite signal that is an output from the antenna 5 into data such as a latitude, a longitude, or an azimuth, and outputs the data to the filtering unit 15 as a satellite positioning result. The satellite positioning result is represented by a format available in the mobile object positioning device 7, for example, a GPGGA format.

The inertial sensor 11 is an angular velocity sensor mounted on the mobile object positioning device 7, and outputs an angular velocity (a yaw rate) generated by turning of the vehicle 1. Embodiment 1 assumes that the inertial sensor 11 is mounted on the mobile object positioning device 7. The inertial sensor 11 may be mounted on the vehicle 1 outside the mobile object positioning device 7, and may enter a detection result into the mobile object positioning device 7. This can reduce the cost of the mobile object positioning device 7.

The sideslip angle estimation unit 12 estimates a sideslip angle by weighting a plurality of motion models based on the vehicle speed and the steering angle received from the mobile object sensor 8 and the yaw rate received from the inertial sensor 11, and outputs an estimated result of the sideslip angle to the filtering unit 15. The sensor correcting unit 13 obtains sensor values from the mobile object sensor 8 and the inertial sensor 11, corrects a sensor error included in each of the sensor values, such as a scale factor or a bias, and outputs the sensor errors to the inertial positioning unit 14 and the filtering unit 15. In other words, the sensor correcting unit 13 functions as a sensor information obtainment unit that obtains sensor values from the mobile object sensor 8 and the inertial sensor 11.

The inertial positioning unit 14 performs inertial positioning computation on, for example, the position, the attitude, and the speed that are the positioning results of the vehicle 1, using the sensor values corrected by the sensor correcting unit 13, and outputs a result of the inertial positioning to the filtering unit 15.

The filtering unit 15 estimates, using the result of the inertial positioning received from the inertial positioning unit 14, an error between the result of the inertial positioning and the sensor value output from the mobile object sensor 8.

### A-2. Operations

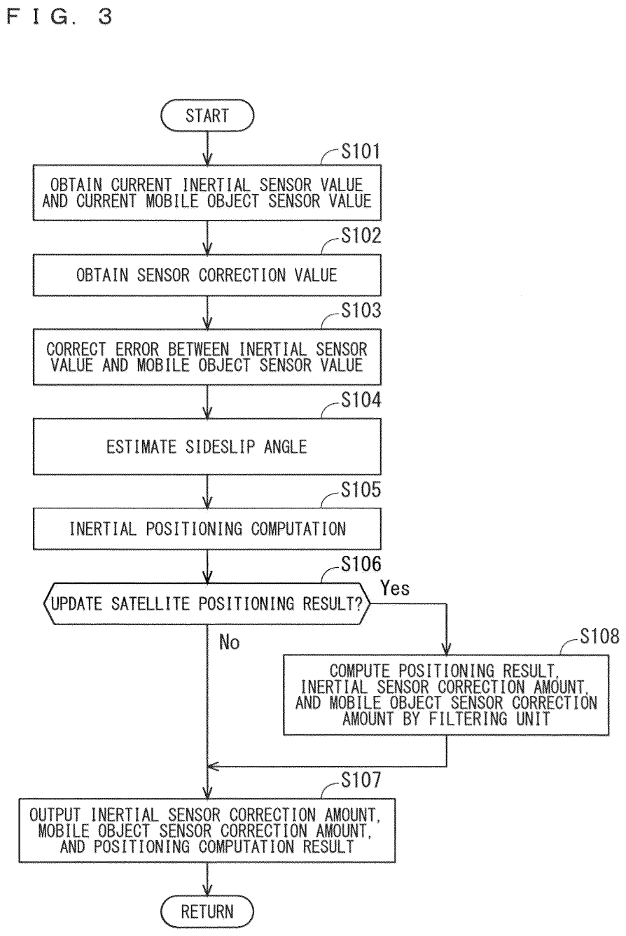

Next, a procedure of processes to be performed by the mobile object positioning device 7 according to Embodiment I will be described with reference to the flowchart in FIG. 3.

Once the mobile object positioning device 7 starts operating, the sensor correcting unit 13 obtains inertial sensor values from the inertial sensor 11, and obtains mobile object sensor values from the mobile object sensor 8 in Step S101. Here, the inertial sensor values include the current angular velocity and the current acceleration of the vehicle 1. Angular velocities include a yaw rate, a pitch rate, a roll rate, and accelerations include a longitudinal acceleration, a lateral acceleration, and a vertical acceleration. Furthermore, the mobile object sensor values include the current steering angle and the current vehicle speed of the vehicle 1.

Next in Step S102, the sensor correcting unit 13 obtains a sensor correction value computed in a previous cycle from the filtering unit 15. In the absence of the previous sensor correction value due to some causes, for example, immediately after power-up, the sensor correcting unit 13 uses an initial value set in advance (0 or a value at the shipment).

Next in Step S103, the sensor correcting unit 13 corrects an error between the inertial sensor value and the mobile object sensor value obtained in Step S101, using the sensor correction value obtained in Step S102, and outputs the corrected error to the filtering unit 15.

Next in Step S104, the sideslip angle estimation unit 12 computes a sideslip angle of the vehicle 1, based on the steering angle and the vehicle speed of the vehicle 1 which have been received from the mobile object sensor 8 and the yaw rate of the vehicle 1 which has been received from the inertial sensor 11, and outputs the sideslip angle to the inertial positioning unit 14.

Here, a method of estimating the sideslip angle by the sideslip angle estimation unit 12 will be described. The sideslip angle estimation unit 12 computes a state of the vehicle 1 using a plurality of vehicle motion models and a weighting function. Embodiment 1 will describe that the sideslip angle estimation unit 12 computes a state of the vehicle 1 using two vehicle motion models and one weighting function. However, the sideslip angle estimation unit 12 may use three or more vehicle motion models or a plurality of weighting functions to compute a state of the vehicle 1.

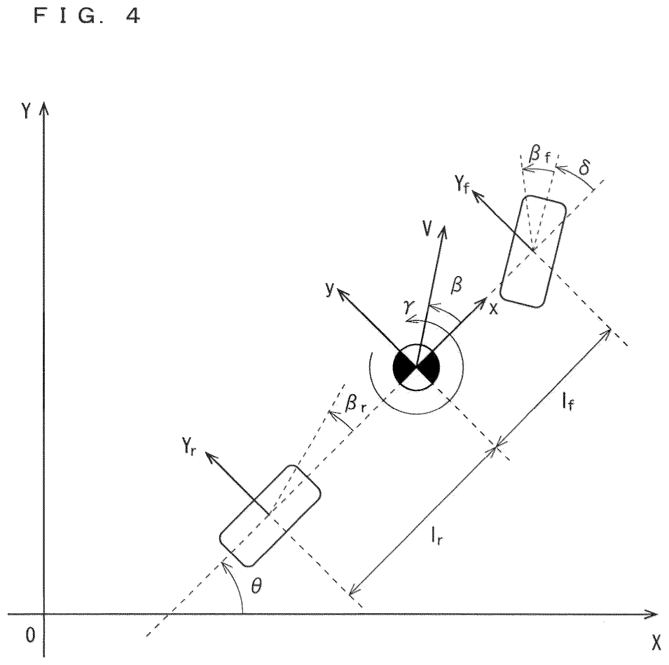

FIG. 4 schematically illustrates a first motion model. The first motion model is a dynamics model using an equation of motion of a transverse direction and rotation of a vehicle. Since this model enables calculation of a vehicle motion corresponding to the force generated by tires, this model can express with high accuracy, particularly, a vehicle motion at a high vehicle speed in which a lateral acceleration is generated in turning. First, a vehicle state quantity x and an input u in a first motion model f₁ are set as below.

$$\begin{matrix}[ Math 1 ] & \\ x = {[ X , Y , θ , V , γ , β , δ , {a}_{x} ]}^{T} & ( 1 )\end{matrix}$$

$$u = {[ ω , {\text{?}}_{x} ]}^{T} \qquad ( 2 )$$

$$\text{?} \text{indicates text missing or illegible when filed}$$

In Equation (1), X, Y, and θ denote a center-of-gravity position and an azimuth angle of the vehicle 1 in an inertial coordinate system, V denotes a vehicle speed, γ denotes a yaw rate, β denotes a sideslip angle, δ denotes a front-wheel steering angle, and aₓ denotes a longitudinal acceleration. In Equation (2), ω denotes a front-wheel steering angle velocity, and jₓ denotes a longitudinal jerk,

The first motion model f₁ is expressed by Equation below, using variables in Equations (1) and (2).

$$\begin{matrix}[ Math 2 ] & \\ {x}^{\text{?}} = {f}_{1} ( x , u ) = [ \begin{matrix}V cos ( θ \text{?} β ) \\ V sin ( θ \text{?} β ) \\ \text{?} \\ \text{?} \\ \frac{\text{?}}{\text{?}} ( {\text{?}}_{\text{?}} {\text{?}}_{\text{?}} - {\text{?}}_{\text{?}} {\text{?}}_{\text{?}} ) \\ - \text{?} \text{?} \frac{\text{?}}{\text{?}} ( {\text{?}}_{\text{?}} + {\text{?}}_{\text{?}} ) \\ ω \\ {f}_{x}\end{matrix} ] & ( 3 )\end{matrix}$$

$$\text{?} \text{indicates text missing or illegible when filed}$$

Here, M denotes a mass of a vehicle, V denotes a vehicle speed, I denotes a yaw moment of inertia of the vehicle, I_{f} denotes a distance from the center of gravity of the vehicle to the front axle, and Iᵣ denotes a distance from the center of gravity of the vehicle to the rear axle. Y_{f} and Yᵣ denote cornering forces of the front wheels and the rear wheels, and are expressed by Equations below using cornering stiffnesses K_{f} and Kᵣ of the front wheels and the rear wheels, respectively.

$$\begin{matrix}[ Math 3 ] & \\ {Y}_{f} = - {K}_{f} ( β \text{?} \frac{\text{?}}{\text{?}} γ - δ ) & ( 4 )\end{matrix}$$

$${Y}_{r} = - {K}_{r} ( β - \frac{\text{?}}{\text{?}} γ ) \qquad ( 5 )$$

$$\text{?} \text{indicates text missing or illegible when filed}$$

Rearranging Equation (3) using Equations (4) and (5) produces Equation below as a dynamics motion model f.

$$\begin{matrix}[ Math 4 ] & \\ {x}^{\text{?}} = {f}_{1} ( x , u ) = [ \begin{matrix}V cos ( θ \text{?} β ) \\ V sin ( θ \text{?} β ) \\ γ \\ {a}_{x} \\ - \frac{\text{?}}{\text{?}} ( {K}_{\text{?}} {\text{?}}_{\text{?}}^{\text{?}} \text{?} {K}_{\text{?}} {\text{?}}_{\text{?}}^{\text{?}} ) γ - \frac{\text{?}}{\text{?}} ( {K}_{\text{?}} {\text{?}}_{\text{?}} - {K}_{\text{?}} {\text{?}}_{\text{?}} ) β \text{?} \frac{\text{?}}{\text{?}} {K}_{\text{?}} {\text{?}}_{\text{?}} δ \\ - ( 1 + \frac{\text{?} ( {K}_{\text{?}} {\text{?}}_{\text{?}} - {K}_{\text{?}} {\text{?}}_{\text{?}} )}{{MV}^{\text{?}}} ) γ - \frac{\text{?}}{\text{?}} ( {K}_{f} - {K}_{r} ) β + \frac{2 {K}_{\text{?}}}{MV} δ \\ ω \\ {f}_{x}\end{matrix} ] & ( 6 )\end{matrix}$$

$$\text{?} \text{indicates text missing or illegible when filed}$$

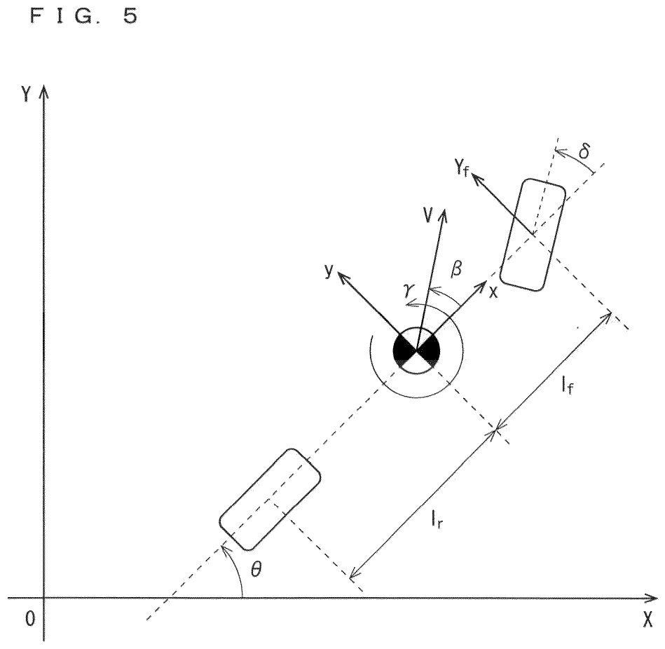

FIG. 5 schematically illustrates a second motion model. The second motion model is a geometric model calculated from a geometric relationship of a vehicle. This model can express with high accuracy a vehicle motion at a low vehicle speed in which the vehicle turns in a direction of tires, without considering the force generated by the tires unlike the first motion model. A vehicle state quantity x and an input u in the second motion model are set identical to those of the first motion model. A second motion model f₂ is expressed by Equation below, using variables in Equations (1) and (2).

$$[ Math 5 ]$$

$$x = {f}_{2} ( x , u ) = [ \begin{matrix}V cos ( θ + β ) \\ V sin ( θ + β ) \\ γ \\ {a}_{x} \\ \frac{{γ}_{km} - γ}{τ} \\ \frac{{β}_{km} - β}{τ} \\ ω \\ {j}_{x}\end{matrix} ] \qquad ( 7 )$$

Here, τ denotes a time constant of the yaw rate γ and the sideslip angle β. Different values of τ may be used for the yaw rate γ and the sideslip angle β. Furthermore, γₖₘ and βₖₘ denote a yaw rate and a sideslip angle that can be calculated from a two-wheel model using a geometric relationship, and are expressed by respective Equations below.

$$[ Math 6 ]$$

$$\text{?} \qquad ( 8 )$$

$$\text{?} \qquad ( 9 )$$

$$\text{?} \text{indicates text missing or illegible when filed}$$

Rearranging Equation (7) using Equations (8) and (9) produces Equation below as a dynamics motion model f₂.

$$[ Math 7 ]$$

$$\text{?} \qquad ( 10 )$$

$$\text{?} \text{indicates text missing or illegible when filed}$$

Although the first motion model f₁ expressed by Equation (6) and the second motion model f₂ expressed by Equation (10) have the same vehicle state quantity x and the same input u, the first motion model f₁ and the second motion model f₂ differ in differential equation on the yaw rate γ and the sideslip angle β. The first motion model and the second motion model are not limited to the aforementioned models, if they have the same vehicle state quantity x and the same input u and have different differential equations on at least one vehicle state quantity.

The second motion model may be, for example, a dynamics model using an equation of motion of a transverse direction and rotation of a vehicle in steady-state cornering. Although this model cannot express a transient motion unlike the first motion model, this model can express a vehicle motion at a low vehicle speed with high accuracy. The second motion model using this model is expressed by Equation below.

$$[ Math 8 ]$$

$$\dot{x} = [ \begin{matrix}V cos ( θ + β ) \\ V sin ( θ + β ) \\ γ \\ {a}_{x} \\ \frac{{γ}_{sst} - γ}{τ} \\ \frac{{β}_{sst} - β}{τ} \\ ω \\ {j}_{x}\end{matrix} ] \qquad ( 11 )$$

Here, γₛₛₜ and βₛₛₜ denote a yaw rate and a sideslip angle, respectively, in steady-state cornering, and are expressed by Equations below.

$$[ Math 9 ]$$

$${γ}_{sst} = \frac{I}{I + {AV}^{2}} \frac{V}{I} δ \qquad ( 12 )$$

$$\text{?} \qquad ( 13 )$$

$$\text{?} \text{indicates text missing or illegible when filed}$$

Here, A is referred to as a stability factor, and is expressed by Equation below.

$$[ Math 10 ]$$

$$\text{?} \qquad ( 14 )$$

$$\text{?} \text{indicates text missing or illegible when filed}$$

In Embodiment 1, a model that is accurate at high vehicle speeds is used as the first motion model, whereas a model that is accurate at low vehicle speeds is used as the second motion model. As such, setting the models with different characteristics to the first motion model and the second motion model and weighting the first motion model and the second motion model using a weighting function to be described later can produce advantages of both of the first motion model and the second motion model.

The weighting function is a function that weights the first motion model and the second motion model, and is set to a value between 0 to 1. Since the first motion model in Embodiment 1 includes division by a vehicle speed, the value diverges in the vicinity of 0 km/h and the accuracy in the vicinity of 0 km/h is inferior. In contrast, the second motion model is a model in which the yaw rate γ and the sideslip angle β are generated by a steering angle, and the force generated in the vehicle is not considered. Thus, the accuracy of the second motion model at high vehicle speeds at which centrifugal force is generated in turning is inferior. Thus, Equation below expresses a weighting function as a function of a speed in which the weight of the first motion model is greater at high speeds and the weight of the second motion model is greater at low speeds.

$$[ Math 11 ]$$

$$α = \frac{{V}^{2}}{{V}^{2} + {V}_{s}^{2}} \qquad ( 15 )$$

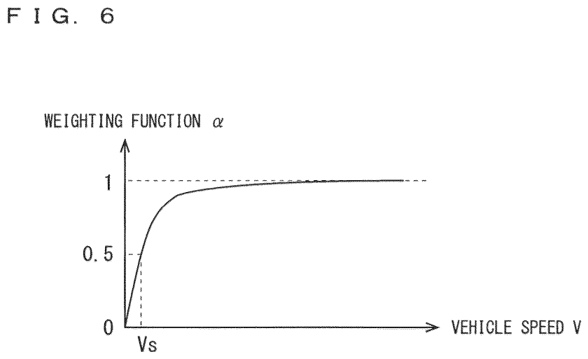

Vₛ is a parameter of a weighting function. When V=Vₛ, the weight of the first motion model is equal to that of the second motion model. FIG. 6 illustrates an example weighting function at this speed. A new vehicle motion model f is built using the first motion model, the second motion model, and this weighting function.

$$[ Math 12 ]$$

$$\dot{x} = f ( x , u ) = {af}_{1} ( x , u ) + ( I + α ) {f}_{2} ( x , u ) \qquad ( 16 )$$

Rearranging this produces Equation below:

$$[ Math 13 ]$$

$$\text{?} \qquad ( 17 )$$

$$\text{?} \text{indicates text missing or illegible when filed}$$

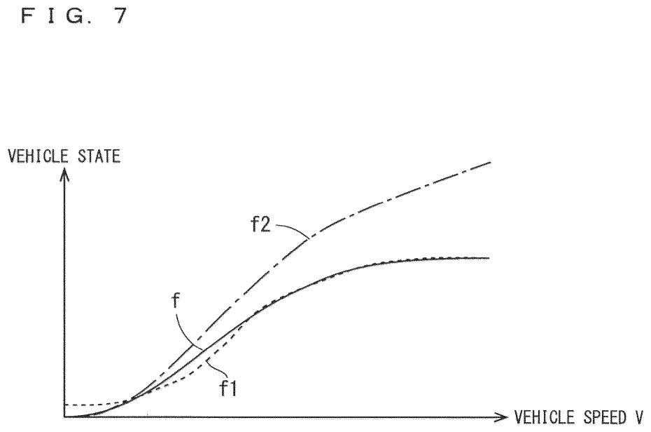

This vehicle motion model f is built by a differential equation having the same vehicle state quantity x and the same input u as those of the first motion model f₁ and the second motion model f₂. This vehicle motion model f will be hereinafter referred to as a mixture model. As illustrated FIG. 7, building a vehicle motion model in this manner computes a vehicle state quantity by the first motion model f₁ when the vehicle speed is high, and computes a vehicle state by the second motion model f₂ when the vehicle speed is low. Thus, the vehicle state quantity can be computed at any vehicle speed with high accuracy. Since the first motion model f₁ and the second motion model f₂ continuously transition by the weighting function α, the vehicle state quantity can be smoothly computed. Furthermore, since the number of elements of the vehicle state quantity x and the number of elements of the control input u are consistent between the first motion model f₁ and the second motion model f₂, an increase in the amount of calculation can be suppressed more than a motion model with high accuracy in which a vehicle state quantity has been increased. In other words, the sideslip angle estimation unit 12 creates a mixture model by weighting a plurality of motion models based on the speed of the vehicle 1.

In Embodiment 1, the weighting function a is a function of which denominator and numerator have respective quadratic terms of the vehicle speed V. However, the weighting function a may be any function such as a polynomial function or an exponential function, as long as the weighting function a is set to a value between 0 to 1. Although the weighting function a is a function of which variable is the vehicle speed V, the weighting function a may be a function with a different variable depending on the first motion model or the second motion model. Furthermore, the weighting function α that differs for each vehicle state quantity to be calculated may be used. For example, assuming that Vₛ₁ denotes a speed of switching a weighting function of the yaw rate γ and Vₛ₂ denotes a speed of switching a weighting function of the sideslip angle β, the mixture model f is expressed as below.

$$[ Math 14 ]$$

$$\text{?} \qquad ( 18 )$$

$$\text{?} \text{indicates text missing or illegible when filed}$$

As such, integrating variations of the sideslip angle β which have been obtained by the mixture model f can estimate the current sideslip angle β.

Thereby, the sideslip angle β can be continuously obtained from when the vehicle 1 stops until vehicle 1 travels at a high speed, and the vehicle 1 can be positioned with high accuracy.

We refer back to FIG. 3. After Step S104, the inertial positioning unit 14 computes variations of the position and the attitude of the vehicle 1, using the sensor correction value received from the sensor correcting unit 13, updates the variations, and outputs the variations as a result of the inertial positioning to the filtering unit 15 in Step S105.

Next, the filtering unit 15 estimates an error between the result of the inertial positioning, the output of the inertial sensor, and the output of the mobile object sensor, using the result of the inertial positioning and the satellite positioning result output from the satellite positioning result receiving unit 10, and outputs the estimated error in Steps S106 to S108.

Specifically, the filtering unit 15 determines whether the satellite positioning result has been updated in this computation cycle in Step S106.

Generally, the computation cycle of satellite positioning is equivalent to and slower than those of the inertial sensor 11 and the mobile object sensor 8. Thus, when the satellite positioning result is not updated, the filtering unit 15 does not update sensor correction amounts for the inertial sensor 11 and the mobile object sensor 8, but outputs a positioning computation result based on the sensor correction amount previously estimated, the inertial sensor value, the mobile object sensor value, and the estimated result of the sideslip angle (Step S107),

When the satellite positioning result has been updated upon computation of the filtering unit 15, the filtering unit 15 computes a sensor correction amount using the satellite positioning result, the inertial sensor value, and the mobile object sensor value (Step S108).

Specifically, the filtering unit 15 applies a filter for determining the sensor correction amounts of the inertial sensor 11 and the mobile object sensor 8, to the error between the satellite positioning result and the result of the inertial positioning which is referred to as loose coupling, using a filter including an extended Kalman filter.

As illustrated in FIGS. 4 and 5, a traveling direction ψ of a vehicle is expressed by Equation below, using the azimuth angle θ and the sideslip angle β of the vehicle.

$$[ Math 15 ]$$

$$ψ = θ + β \qquad ( 19 )$$

Since an azimuth angle obtained by satellite positioning is determined by the amount of movement and the moving speed of an antenna, the azimuth angle θ of the vehicle is expressed by Equation below using Equation (19).

$$[ Math 16 ]$$

$$θ = ψ - β \qquad ( 20 )$$

The inertial positioning unit 14 calculates a result of the inertial positioning by, for example, defining a state variable as indicated below, using the azimuth angle θ of the vehicle 1 with consideration given to the sideslip angle β which has been obtained as described above.

$$[ Math 17 ]$$

$${{y}_{d} [ \begin{matrix}{λ}_{d} & {ϕ}_{d} & {h}_{d} & {θ}_{d}\end{matrix} ]}^{T} \qquad ( 21 )$$

y_{d} in Equation (21) denotes a state vector on inertial positioning which has been obtained by combining state variables on inertial positioning. Furthermore, λ_{d} denotes a latitude, φ_{d} denotes a longitude, and h_{d} denotes an ellipsoidal height, all of which have been obtained by inertial positioning computation. θ_{d} denotes the azimuth angle with consideration given to the sideslip angle β which has been obtained by Equation (20).

A vector obtained by time-deriving y_{d} in Equation (21) is expressed below.

$$[ Math 18 ]$$

$${\dot{y}}_{d} = g ( {y}_{d} , u )$$

An input below is expressed as a vector u.

$$[ Math 19 ]$$

$${[ \hat{V} , \hat{γ} ]}^{T}$$

$$[ Math 20 ]$$

$$\hat{V} , \hat{γ}$$

represent the vehicle speed V and the yaw rate γ between which an error has been corrected by the sensor correcting unit 13.

Substituting y_{d} and the input u at one prior step into

$$g ( {y}_{d} , u )$$

and momentarily integrating these can obtain a result of the inertial positioning.

The filtering unit 15 estimates an error between a state quantity and a sensor through a Kalman filter, using the result of the inertial positioning with consideration given to the sideslip angle B which has been determined in the aforementioned manner.

Specifically, the filtering unit 15 performs the estimation using the following sensor models.

$$[ Math 22 ]$$

$$V = ( I + {s}_{V} ) {V}_{t} \qquad ( 22 )$$

$$γ = ( I + {s}_{γ} ) ( {γ}_{t} + {b}_{γ} ) \qquad ( 23 )$$

Equation (22) is a model in which a true value Vₜ of a vehicle speed is multiplied by a scale factor S_{γ} of the vehicle speed. Equation (23) is a model in which a bias b_{γ} of a yaw rate sensor is superimposed on a true value γₜ of a yaw rate and the resultant is multiplied by a scale factor s_{γ} of the yaw rate.

In this example, the filtering unit 15 estimates, as sensor errors, estimated values s_{γ}e, s_{γ}e, and b_{γe} of s_{γ}, s_{γ}y, and b_{γ}y, respectively. The sensor correcting unit 13 corrects sensor values of the mobile object sensor 8 and the inertial sensor 11 through Equations below, using the estimated values produced by the filtering unit 15.

$$[ Math 23 ]$$

$${V}_{e} = \frac{I}{( I - {s}_{{V}_{e}} )} V \qquad ( 24 )$$

$${γ}_{e} = \frac{I}{( I - {s}_{γ} )} γ - {b}_{γ e} \qquad ( 25 )$$

The filtering unit 15 defines a state vector as indicated by Equation below.

$$[ Math 24 ]$$

$$x = {[ \begin{matrix}λ & ϕ & h & θ & {s}_{V} & {s}_{γ} & {b}_{γ}\end{matrix} ]}^{T} \qquad ( 26 )$$

Assuming that the scale factor Sᵥ of the vehicle speed and the scale factor s_{γ} of the yaw rate are minute, the true value Vₜ of the vehicle speed and the true value γₜ of the yaw rate can be approximated by respective Equations below.

$$[ Math 25 ]$$

$${V}_{t} = ( I - {s}_{V} ) V \qquad ( 27 )$$

$${γ}_{t} = ( I - {s}_{γ} ) γ - {b}_{γ} \qquad ( 28 )$$

Dynamics models of the scale factor Sᵥ of the vehicle speed, the scale factor s_{γ} of the yaw rate, and the bias b_{γ} of the yaw rate sensor are expressed by Equations below. The dynamics models are driven by a first-order Markov process of predicting a next state from the current state.

$$[ Math 26 ]$$

$${\dot{s}}_{V} = ( - {s}_{V} + {w}_{{s}_{V}} ) / {τ}_{{s}_{V}} \qquad ( 29 )$$

$${\dot{s}}_{γ} = ( - {s}_{γ} + {w}_{{s}_{γ}} ) / {τ}_{{s}_{γ}} \qquad ( 30 )$$

$${\dot{b}}_{γ} = ( - {b}_{γ} + {w}_{{b}_{γ}} ) / {τ}_{{b}_{γ}} \qquad ( 31 )$$

In Equations (29) to (31):

$$[ Math 27 ]$$

$${\dot{s}}_{V}$$

denotes time derivation of sᵥ;

$$[ Math 28 ]$$

$${\dot{s}}_{γ}$$

denotes time derivation of s_{γ}; and

$$[ Math 29 ]$$

$${\dot{b}}_{γ}$$

denotes time derivation of b_{γ}. Furthermore, τ_{sV} denotes a model parameter value of a vehicle speed scale factor. W_{sV} denotes noise on time transition of the vehicle speed scale factor. τ_{sγ} denotes a model parameter value of a yaw rate scale factor. W_{sγ} denotes noise on time transition of the yaw rate scale factor. τ_{bγ} denotes a model parameter value of a yaw rate bias. W_{bγ} denotes noise on time transition of the yaw rate bias.

Rearranging Equations (29) to (31) expresses an equation of state by Equation (32) below.

$$[ Math 30 ]$$

$$\dot{x} = f ( x , u ) \qquad ( 32 )$$

In Equation (32),

$$[ Math 31 ]$$

$$\dot{x}$$

denotes a vector obtained by time-deriving a state vector x. Furthermore, u denote an input vector below.

$$[ Math 32 ]$$

$${[ V , γ ]}^{T}$$

Next, an observation value of a Kalman filter which is obtained from the satellite positioning result receiving unit 10 will be described. The satellite positioning result receiving unit 10 outputs coordinate information such as a latitude, a longitude, and an altitude of the antenna 5. Observation values of a GNSS sensor will be hereinafter denoted by (λₘ, φₘ, hₘ, ψₘ). These pieces of coordinate information are obtained from a result of the inertial positioning. However, the result of the inertial positioning is coordinates of a vehicle at the navigation center. Thus, the observation values of the GNSS sensor are predicted using an offset amount from the navigation center of the vehicle to the position of the antenna 5. In other words, assuming that (Δx, Δy, Δz) denotes the offset amount from the navigation center of the vehicle to the antenna 5 which is represented by a navigation coordinate system of the vehicle, the predicted observation values of the GNSS sensor λp, φp, hp, ψp) are determined as Equation (33) below from an inertial positioning value y_{d} and an offset amount v (Δx, Δy, Δz) using a coordinate conversion function c (y_{d}, v).

$$[ Math 33 ]$$

$$[ \begin{matrix}{λ}_{p} \\ {ϕ}_{p} \\ {h}_{p} \\ {ψ}_{p}\end{matrix} ] = c ( {t}_{d} , v ) \qquad ( 33 )$$

As such, a state is estimated using the equation of state of Equation (32) and the observation equation of Equation (33) with application of an extended Kalman filter. This can give an estimated value of the state vector of Equation (26) and determine a position error and a sensor error.

The inertial positioning unit 14 uses an azimuth angle with consideration given to a sideslip angle as described above, so that the accuracy of the result of the inertial positioning and the accuracy of the state quantity and the sensor error that are estimated by the filtering unit 15 will be improved.

As described above, the mobile object positioning device 7 according to Embodiment 1 includes: the sensor information obtainment unit that obtains sensor values including a steering angle, a vehicle speed, and an angular velocity of the vehicle 1 which have been detected by the mobile object sensor 8 and the inertial sensor 11 that are sensors mounted on the vehicle 1 that is a mobile object; the inertial positioning unit 14 that performs inertial positioning of the vehicle I using the sensor values; and the sideslip angle estimation unit 12 that estimates a sideslip angle of the vehicle 1 using the sensor values. Then, the sideslip angle estimation unit 12 estimates the sideslip angle, based on the sensor values and the mixture model f obtained by weighting the plurality of motion models f1 and f2 having different differential equations on at least one of state quantities of the vehicle 1, based on the state quantities of the vehicle 1, and integrating the motion models f1 and f2. Thus, the mobile object positioning device 7 can estimate the sideslip angle of the vehicle 1 even when the vehicle 1 is not in a steady state, and can estimate the position and the attitude of the vehicle 1 with high accuracy. Thereby, for example, when the mobile object positioning device 7 is used for an application such as the automated driving, the control safety and the riding comfort of the vehicle 1 will be improved.

The mobile object positioning device 7 further includes: the filtering unit 15 that estimates a sensor error included in each of the sensor values, using a result of the inertial positioning and the sideslip angle; and the sensor correcting unit 13 that corrects the sensor error included in the sensor value, and the inertial positioning unit 14 may perform the inertial positioning using the sensor value corrected by the sensor correcting unit 13.

### A-3. Modifications

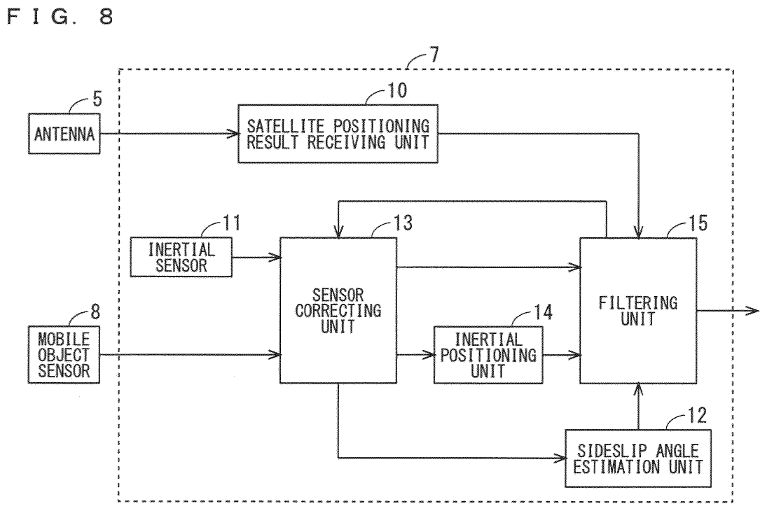

In the configuration of FIG. 2, the sensor values of the mobile object sensor 8 and the inertial sensor 11 are input to the sideslip angle estimation unit 12. However, the sensor values corrected by the sensor correcting unit 13 may be input to the sideslip angle estimation unit 12 as illustrated in FIG. 8. In other words, the sideslip angle estimation unit 12 may estimate a sideslip angle based on the sensor values corrected by the sensor correcting unit 13. This reduces an error included in the input to the sideslip angle estimation unit 12, and improves the accuracy of estimating the sideslip angle.

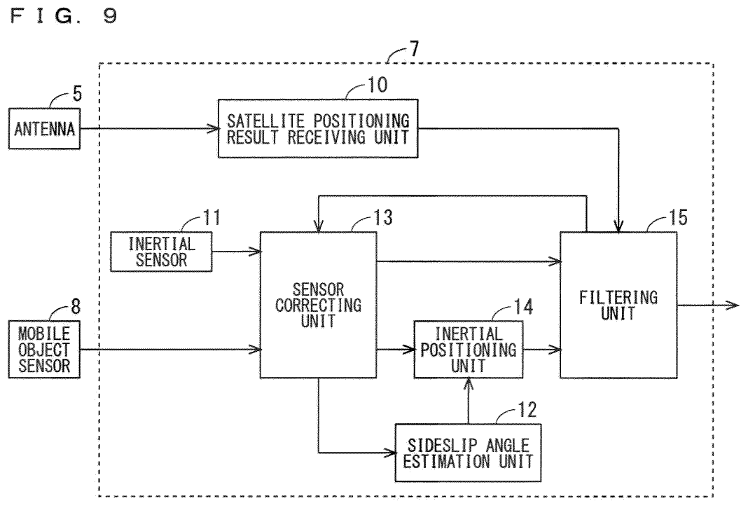

In the configuration of FIG. 2, the estimated result of the sideslip angle by the sideslip angle estimation unit 12 is output to the filtering unit 15. However, the estimated result of the sideslip angle by the sideslip angle estimation unit 12 may be output to the inertial positioning unit 14 as illustrated in FIG. 9. In other words, the inertial positioning unit 14 may perform inertial positioning in consideration of the sideslip angle, using the sideslip angle.

Specifically, the inertial positioning unit 14 performs inertial positioning computation in consideration of the sideslip angle β, by changing the observation values (λm, φm, hm, ψm) of the GNSS sensor into values with consideration given to the sideslip angle β, that is, ((λₘ, φₘ, hₘ, ψₘ·β). This improves the accuracy of estimating the azimuth angle by the inertial positioning.

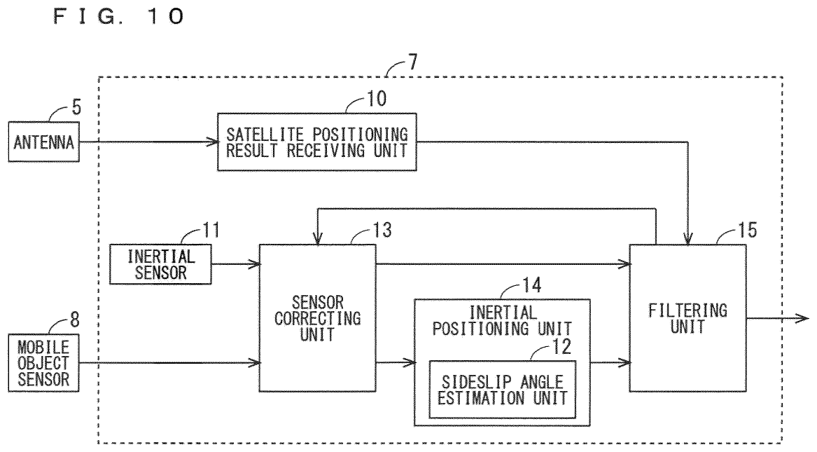

Furthermore, the inertial positioning unit 14 may include the sideslip angle estimation unit 12 as illustrated in FIG. 10. In other words, the inertial positioning unit 14 may perform the inertial positioning computation, using the model used by the sideslip angle estimation unit 12 for estimating the sideslip angle. In other words, the mobile object positioning device 7 may include: the sensor information obtainment unit that obtains sensor values including a steering angle, a vehicle speed, and an angular velocity of the vehicle 1 which have been detected by the mobile object sensor 8 and the inertial sensor 11 that are sensors mounted on the vehicle 1; the sensor correcting unit 13 that corrects a sensor error included in each of the sensor values; the inertial positioning unit 14 that performs inertial positioning of the vehicle 1 using the sensor value corrected by the sensor correcting unit 13; and the filtering unit 15 that estimates the sensor error included in the sensor value, using a result of the inertial positioning and the sideslip angle of a mobile object. Furthermore, the inertial positioning unit 14 may estimate the sideslip angle, based on the sensor values and the mixture model f obtained by weighting the plurality of motion models f1 and f2 having different differential equations on at least one of the state quantities of the vehicle 1, based on the state quantities of the vehicle 1, and integrating the motion models f1 and f2.

Specifically, the front-wheel steering angle & may be added to an input expressed below to a Kalman filter.

$$[ Math 34 ]$$

$${[ \hat{V} , \hat{γ} ]}^{T}$$

Furthermore, a model of the azimuth angle θ of the vehicle 1 in an equation of state expressed below to be used for a Kalman filter may be changed into a more detailed model not limited to integration of yaw rates but the one indicated by Equation (18).

$$[ Math 35 ]$$

$$\dot{x} = f ( x , u )$$

As such, weighting and estimating a plurality of motion models by the inertial positioning unit 14 increases the accuracy of the motion models to be used for the inertial positioning, and improves the estimation accuracy.

In Embodiment 1, the latitude, the longitude, the altitude, and the azimuth obtained through the positioning computation by the GNSS sensor are used as observation values of the GNSS. Since some GNSS sensors can output raw data such as a pseudo range, Doppler data, carrier phases, a tight coupling using these as observation values may be used. This case sometimes requires adding, for example, a drift of a receiver time of the GNSS sensor to a state variable and estimating an error on the receiver time. However, even when the number of visible satellites is few, for example, only one, the tight coupling can generate the observation values of the GNSS. This enables highly accurate positioning even when the number of visible satellites is few.

Furthermore, although the number of the antenna 5 is one in Embodiment 1, a structure with a plurality of antennas which allows calculation of an azimuth using positions and speeds of the antennas may be used. In other words, the filtering unit 15 estimates a traveling direction of the vehicle 1 using satellite signals received from the satellite 4 through the plurality of antennas 5 mounted on the vehicle 1, and estimates a sensor error based on a result of the inertial positioning, the sideslip angle, and the traveling direction of the vehicle 1. This enables the filtering unit 15 to calculate movement or rotation of the vehicle from mutual positions of the antennas 5 and estimate the azimuth with higher accuracy.

### A-4. Hardware Configuration

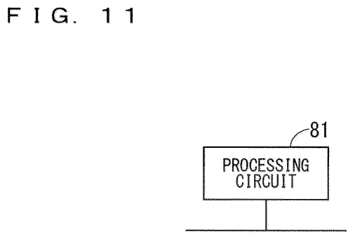

A processing circuit 81 in FIG. 11 implements the satellite positioning result receiving unit 10, the sideslip angle estimation unit 12, the sensor correcting unit 13, the inertial positioning unit 14, and the filtering unit 15 in the aforementioned mobile object positioning device 7. In other words, the processing circuit 81 includes the satellite positioning result receiving unit 10, the sideslip angle estimation unit 12, the sensor correcting unit 13, the inertial positioning unit 14, and the filtering unit 15 (hereinafter referred to as “the sideslip angle estimation unit 12, etc.,”). This processing circuit 81 may be dedicated hardware, or a processor that executes a program stored in a memory. The processor is, for example, a central processing unit, a processing unit, an arithmetic unit, a microprocessor, a microcomputer, or a digital signal processor (DSP).

When the processing circuit 81 is dedicated hardware, the processing circuit 81 is, for example, a single circuit, a composite circuit, a programmed processor, a parallel-programmed processor, an application-specific integrated circuit (ASIC), a field-programmable gate array (FPGA), or any combination of these. The functions of each of the units, that is, the sideslip angle estimation unit 12, etc., may be implemented by a plurality of processing circuits 81, or the functions of the units may be collectively implemented by a single processing circuit.

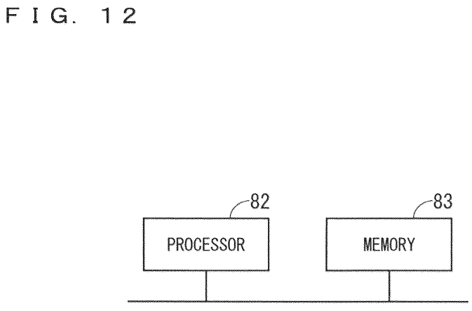

When the processing circuit 81 is a processor, the functions of the sideslip angle estimation unit 12, etc., are implemented by any combinations of software, etc., (software, firmware, or the software and the firmware), For example, the software is described as a program, and stored in a memory. As illustrated in FIG. 12, a processor 82 to be employed as the processing circuit 81 implements the functions of each of the units by reading and executing a program stored in a memory 83. In other words, the mobile object positioning device 7 includes the memory 83 for storing a program which, when executed by the processing circuit 81, consequently executes the functions of each of the units. Put it differently, this program causes a computer to execute procedures or methods for the sideslip angle estimation unit 12, etc. Here, examples of the memory 83 may include non-volatile or volatile semiconductor memories such as a random access memory (RAM), a read-only memory (ROM), a flash memory, an erasable programmable read only memory (EPROM), and an electrically erasable programmable read-only memory (EEPROM), a hard disk drive (HDD), a magnetic disc, a flexible disk, an optical disk, a compact disk, a mini disk, a Digital Versatile Disc (DVD), a drive device thereof, and further any storage medium to be used in the future.

The configuration for implementing the functions of the sideslip angle estimation unit 12, etc., using one of the hardware and the software, etc., is described above. However, the configuration is not limited to this but a part of the sideslip angle estimation unit 12, etc., may be implemented by dedicated hardware, and another part thereof may be implemented by software, etc.

The embodiments can be freely combined, or appropriately modified and omitted. The aforementioned description is in all aspects illustrative. It is understood that numerous modifications that have not yet been exemplified can be devised.

Although the vehicle 1 is exemplified as a mobile object, the mobile object is not limited to a vehicle. Examples of the mobile object include various kinds of inspection robots and personal mobility devices.

### EXPLANATION OF REFERENCE SIGNS

1 vehicle, 2 steering wheel, 3 steering actuator, 4 satellite, 5 antenna, 6 drive, 7 mobile object positioning device, 8 mobile object sensor, 9 vehicle controller, 10 satellite positioning result receiving unit, 11 inertial sensor, 12 sideslip angle estimation unit, 13 sensor correcting unit, 14 inertial positioning unit, 15 filtering unit.

1. A mobile object positioning device, comprising:
a processor to execute a program; and
a memory to store the program which, when executed by the processor, performs processes of:
obtaining a sensor value on a mobile object, the sensor value being detected by a sensor;
estimating a sideslip angle of the mobile object using the sensor value; and
performing inertial positioning of the mobile object using the sensor value and the sideslip angle,
wherein the estimating includes estimating the sideslip angle based on a mixture model and the sensor value, the mixture model being obtained by weighting a plurality of motion models on the mobile object based on state quantities of the mobile object and integrating the plurality of motion models.

2. A mobile object positioning device, comprising:
a processor to execute a program; and
a memory to store the program which, when executed by the processor, performs processes of:
obtaining a sensor value on a mobile object, the sensor value being detected by a sensor;
obtaining a sensor correction value computed in a previous cycle, and correcting a sensor error included in the sensor value, using the sensor correction value;
performing inertial positioning of the mobile object using the sensor value corrected in the obtaining and the correcting; and
estimating the sensor error included in the sensor value, using a result of the inertial positioning and a sideslip angle of the mobile object, and outputting the estimated sensor error as the sensor correction value,
wherein the sideslip angle is estimated based on a mixture model and the sensor value, and performs the inertial positioning is performed using the sideslip angle, the mixture model being obtained by weighting a plurality of motion models on the mobile object based on state quantities of the mobile object and integrating the plurality of motion models.

3.-5. (canceled)

6. The mobile object positioning device according to claim 2,
wherein a traveling direction of the mobile object is estimated using satellite signals received from a satellite through a plurality of antennas mounted on the mobile object, and the sensor error is estimated based on the result of the inertial positioning, the sideslip angle, and the traveling direction of the mobile object.

7. The mobile object positioning device according to claim 2,
wherein the mixture model is created by weighting the plurality of motion models based on a speed of the mobile object.
